(19) United States
(12) Patent Application Publication
(10) Pub. No.: US 2014/0262606 A1
(43) Pub. Date: Sep. 18, 2014

(54) SOUND ABSORBING BODY AND DEVICE

(71) Applicant: SEIKO EPSON CORPORATION, Tokyo (JP)

(72) Inventor: Kiyoshi TSUJINO, Matsumoto (JP)

(73) Assignee: SEIKO EPSON CORPORATION, Tokyo (JP)

(21) Appl. No.: 14/196,597

(22) Filed: Mar. 4, 2014

(30) Foreign Application Priority Data
Mar. 14, 2013 (JP) 2013-051380

(51) Int. Cl. B32B 27/00

(52) U.S. Cl. CPC B32B 27/00
USPC 181/284

(57) ABSTRACT

A sound absorbing body includes fibers as a main constituent. A density of the sound absorbing body differs for one surface side and the other surface side in a thickness direction. A color of the sound absorbing body differs for the one surface side and the other surface side.

### CROSS-REFERENCE TO RELATED APPLICATIONS

This application claims priority to Japanese Patent Application No. 2013-051380 filed on Mar. 14, 2013. The entire disclosure of Japanese Patent Application No. 2013-051380 is hereby incorporated herein by reference.

### BACKGROUND

1. Technical Field

The present invention relates to a sound absorbing body and a device.

2. Related Art

In the past, a multilayer sound absorbing material for which a hard layer having a dense part with high density and a soft layer having a non-dense part with lower density than the dense part are laminated has been known (see Japanese Unexamined Patent Publication No. 2010-85873, for example).

### SUMMARY

However, with the multilayer sound absorbing material noted above, it is not easy to distinguish between which surface is the hard layer and which surface is the soft layer, so for example when attaching the multilayer sound absorbing material to some kind of apparatus, there was the problem of making an error in the attachment direction.

The present invention was created to address at least a portion of the problems described above, and can be realized as the modes or aspects below.

A sound absorbing body according to one aspect includes fibers as a main constituent. A density of the sound absorbing body differs for one surface side and the other surface side in a thickness direction. A color of the sound absorbing body differs for the one surface side and the other surface side.

With this constitution, for example, when sound enters from the non-dense part for which the density of one surface side of the sound absorbing body is rough, the sound that entered the sound absorbing body is reflected by the dense part for which the density is higher than the non-dense part formed on the other surface side. Then, the reflected sound is again propagated in the non-dense part. Then, the sound is attenuated in this process, and it is possible to increase the sound absorbing properties. Also, the sound absorbing body is constituted as one unit. Specifically, it is formed as an integral unit. Because of this, for example, compared to when the dense part and the non-dense part are formed separately and alternately laminated, management of the adhesion and the like at the lamination boundaries is unnecessary, and it is possible to perform handling easily. Also, the color of the one surface and the color of the other surface are different. Specifically, the color corresponding to the dense part and the color corresponding to the non-dense part are different. By doing this, it is easy to distinguish with the sound absorbing body which surface corresponds to the dense part and which surface corresponds to the non-dense part. Therefore, for example when arranging the sound absorbing body on an apparatus of some sort, it is possible to reliably attach it without making an error in the non-dense/dense direction of the sound absorbing body.

The sound absorbing body of the aspect noted above is preferably attached to an apparatus. One of the one surface and the other surface of the sound absorbing body attached to the apparatus preferably corresponds to a dense part for which the density is high, and coloring is preferably implemented on the one of the one surface and the other surface of the sound absorbing body corresponding to the dense part.

With this constitution, the surface having the dense density part is arranged on the apparatus side, so the non-dense part with rough density becomes the front surface side. Then, the side of the surface by which the sound absorbing body is attached to that apparatus is colored, so when attaching the sound absorbing body to that apparatus, it is possible to arrange it without making an error in the sound absorbing body attachment surface. Also, because the colored surface side of the sound absorbing body is hidden by being attached to the apparatus, it is not possible to visually recognize the colored surface. Because of that, it is not particularly necessary to restrict the color used for coloring, and it is possible to use an inexpensive coloring material. As the apparatus to which the sound absorbing body is attached, it is possible to apply this to case members of various types of devices, as well as to drive heads, motors and the like.

With the sound absorbing body of the aspect noted above, the density of the sound absorbing body is preferably the density of the fibers, and the fibers are preferably colored.

With this constitution, fibers themselves of different densities are colored, so the dense part looks darker than the non-dense part. By doing this, the colors of the surface having the dense part and the surface having the non-dense part look different, so they are easy to distinguish. Also, it is not necessary to do coloring after the sound absorbing body is formed, so it is possible to reduce the man hours.

With the sound absorbing body of the aspect noted above, the sound absorbing body preferably includes the dense part and a non-dense part with a lower density than the dense part. The dense part preferably includes more fibers for which a fiber length is shorter than that of the non-dense part.

With this constitution, for example, by forming the fiber while suctioning, and biasing the short fibers to one side, it is easy to form the dense part and the non-dense part.

With the sound absorbing body of the aspect noted above, the sound absorbing body preferably includes flame retardant. The density of the sound absorbing body is preferably the density of the flame retardant, and the flame retardant is preferably colored.

With this constitution, the flame retardant contained in the sound absorbing body is colored, so the dense part looks darker than the non-dense part. By doing this, the colors of the surface having the dense part and the surface having the non-dense part look different, making it possible to distinguish them. Also, it is not necessary to do coloring after the sound absorbing body is formed, so it is possible to reduce the man hours.

With the sound absorbing body of the aspect noted above, the sound absorbing body preferably includes molten resin. The density of the sound absorbing body is preferably the density of the molten resin, and the molten resin is preferably colored.

With this constitution, the molten resin contained in the sound absorbing body is colored, so the dense part looks darker than the non-dense part. By doing this, the colors of the surface having the dense part and the surface having the non-dense part look different, making it possible to distinguish them. Also, it is not necessary to do coloring after the sound absorbing body is formed, so it is possible to reduce the man hours.

With the sound absorbing body of the aspect noted above, coloring is preferably done by writing a symbol on the one of the one surface and the other surface of the sound absorbing body attached to the apparatus.

With this constitution, it is easy to distinguish the attached surface, and it is possible to increase work efficiency. Also, since the symbol is written on the attached surface, after the sound absorbing body is attached, that symbol can no longer be seen. Therefore, it is possible to prevent the occurrence of problems with the external appearance. Symbols include various types of letters, alphanumeric characters, marks and the like. Furthermore, by expressing the specified attachment position and sequence on the apparatus as symbols, it is possible to increase workability.

The sound absorbing body of the aspect noted above is preferably attached to an apparatus. One of the one surface and the other surface of the sound absorbing body attached to the apparatus preferably corresponds to a dense part with high density, and coloring is preferably implemented on the other of the one surface and the other surface of the sound absorbing body corresponding to a non-dense part which has a lower density than the dense part.

With this constitution, the surface having the dense density part is arranged on the apparatus side, so the non-dense part with rough density becomes the front surface side. Then, since the front surface side of the sound absorbing body in relation to the apparatus is colored, when attaching the sound absorbing body to the apparatus, it is possible to prevent making an error in the sound absorbing body attachment surface. Also, since the front surface side is colored, it is possible to improve the design characteristics.

With the sound absorbing body of the aspect noted above, the color used for coloring is preferably similar to a color of the apparatus attachment surface

With this constitution, by having the color of the front surface of the sound absorbing body be similar to the color of the apparatus, it is possible to not have the existence of the sound absorbing body stand out.

A device according to another aspect includes the sound absorbing body noted above, and an apparatus.

With this constitution, it is possible to provide a device which has an excellent sound absorption effect, and furthermore, for which coloring is implemented on the surface of the sound absorbing body to make it easy to assemble. Here, as the device, for example, this includes various electronic devices that emit sound such as a printer or the like, as well as other various types of apparatus.

### BRIEF DESCRIPTION OF THE DRAWINGS

Referring now to the attached drawings which form a part of this original disclosure:

FIGS. 1A to 1D are pattern diagrams showing the constitution of a sound absorbing body of the first embodiment.

FIG. 2 is a cross section diagram showing the constitution of the printer.

FIGS. 3A to 3D are pattern diagrams showing the constitution of a sound absorbing body of the second embodiment.

FIGS. 4A to 4D are pattern diagrams showing the constitution of a sound absorbing body of the third embodiment.

### DETAILED DESCRIPTION OF EXEMPLARY EMBODIMENTS

Following, we will describe embodiments 1 through 3 of the present invention while referring to the drawings. In each drawing hereafter, to make each component and the like be a size of a level that is recognizable, the scale of each component and the like is shown different from actuality.

### First Embodiment

First, we will describe the constitution of the sound absorbing body. FIGS. 1A to 1D are pattern diagrams showing the constitution of the sound absorbing body of this embodiment. The sound absorbing body 200 is an item for which fibers are the main constituent, and for example, is an item attached to the surface of a case member of an apparatus, for absorbing noise generated from the apparatus (doing sound absorption). FIG. 1A is a lateral cross section view. As shown in FIG. 1A, the density differs between one surface side and the other surface side in the thickness direction T of the rectangular solid form sound absorbing body 200, and the color also differs between one surface and the other surface.

The sound absorbing body 200 is formed as one unit (one item), and the one surface 200a side in the thickness T direction of that sound absorbing body 200 is the dense part 210 with the high density, and the other surface 200b side is the non-dense part 200 with lower density than the dense part 210. Then, the dense part 210 includes many fibers with shorter fiber length than the non-dense part 220. With the sound absorbing body 200 constituted in this way, for example, when sound enters from the non-dense part 220, the entered sound passes through the non-dense part 220 and is reflected by the dense part 210. Then, the reflected sound is again propagated in the non-dense part 220. Then, the sound is attenuated by this process. By doing this, it is possible to obtain a sound absorption effect.

It is also possible to laminate a plurality of sound absorbing bodies 200. By doing this, it is possible to further increase the sound absorbing effect.

The sound absorbing body 200 is an item formed from a mixture including cellulose fiber, molten resin, and flame retardant, and the density of the non-dense parts 220 and the dense parts 210 is stipulated by the density of at least one of the cellulose fiber, the molten resin, or the flame retardant.

The cellulose fiber is an item for which a pulp sheet or the like is fibrillated into fiber form using a dry type defibrating machine such as a rotary crushing device, for example. The molten resin is an item that binds between cellulose fibers, maintains suitable strength (hardness or the like) for the sound absorbing body 200, prevents paper powder and fiber from scattering, and contributes to maintaining the shape of the sound absorbing body 200. For the molten resin, it is possible to use various modes such as fiber form, powder form and the like. Then, by heating the mixture with cellulose fiber and molten resin mixed, it is possible to melt the molten resin, and to fuse the cellulose fibers and harden them. It is preferable to fuse at a temperature of a level that will not cause thermal degradation of the cellulose fibers and the like. Also, it is preferable that the molten resin be in a fiber form that easily entwines with cellulose fibers in the fibrillated material. Furthermore, it is preferable to use a core-sheath structure conjugated fiber. With the core-sheath structure molten resin, the surrounding sheath part melts at a low temperature, and by the fiber form core part bonding with the molten resin itself or with the cellulose fiber, it is possible to make a strong bond.

The flame retardant is an item added to give flame resistance to the sound absorbing body 200. As the flame retardant, for example, it is possible to use inorganic materials such as aluminum hydroxide, magnesium hydroxide and the like, or phosphorous based organic materials (e.g. aromatic phosphate such as triphenylphosphate or the like).

As the sound absorbing body 200 forming method, for example, a mixture for which cellulose fiber, molten resin, and flame retardant are mixed are placed in a sieve, and this is deposited on a mesh belt arranged beneath the sieve to form a deposit. At this time, for example, depositing is done while suctioning using a suction device. By doing this, it is possible to deposit while biasing the short fibers to one surface side, and to form the dense part at one surface side. Then, the formed deposited substance undergoes pressurization heat treatment. By doing this, the molten resin is melted, and this is formed to a desired thickness. Furthermore, by die cutting to a desired dimension, the sound absorbing body 200 is formed.

FIG. 1B is a plan view of the sound absorbing body 200 seen from one surface 200a side, and FIG. 1C is a plan view of the sound absorbing body 200 seen from the other surface 20013 side. As shown in FIGS. 1B and 1C, the color is different with the one surface 200a and the other surface 200b. With this embodiment, coloring is implemented on the one surface 200a. Specifically, coloring is implemented on the surface corresponding to the dense part 210. In specific terms, the cellulose fiber, molten resin, or flame retardant is colored. As a coloring agent, for example, it is possible to suitably use carbon black, a pigment power or the like.

The coloring method is not particularly restricted. For example, it is possible to do coloring by depositing a mixture for which cellulose fiber, molten resin, and flame retardant are mixed on a colored layer for which a coloring agent was laminated, and by doing pressurization heat treatment of the deposited material made by the colored layer and the mixture. Also, after the sound absorbing body 200 is formed, it is possible to color the one surface 200a using a printing device, or to write using spraying or various writing instruments or the like. Also, as the coloring method, it is possible to color the entire one surface 200a, or to implement coloring on only a portion of the one surface 200a. Also, coloring can be constituted using only one color, or with a plurality of colors. Furthermore, it is also possible to express the color as a symbol. Here, a symbol is not particularly restricted as long as it is colored, including letters, numbers, marks or the like. It is also possible to note as a symbol the specified position and sequence for attaching to the apparatus. By working in this way, it is possible to improve workability.

FIG. 1D is a pattern diagram showing the method of attaching the sound absorbing body 200 to an apparatus M. As shown in FIG. 1D, the surface corresponding to the dense part 210 of the sound absorbing body 200, specifically, the one surface 200a, is attached to the case surface 1a of the case member 1 of the apparatus M. Therefore, the other surface 200b corresponding to the non-dense part 220 is arranged on the front surface side.

The one surface 200a in relation to the dense part 210 is attached to the apparatus M side, so sound easily passes through from the non-dense part 220 which is the front surface side, and it is possible to do sound absorption. Furthermore, because coloring is implemented on the one surface 200a side which is the surface of the sound absorbing body 200 attached to the apparatus M, when attaching the sound absorbing body 200 to the apparatus M, it is possible to prevent making errors in the attachment surface of the sound absorbing body 200. Also, the colored one surface 200a is hidden from the surface of the sound absorbing body 200 by being attached to the apparatus, so it is no longer possible to visually recognize the colored surface. Because of this, there is no longer a need to specifically limit the color for coloring, and it is possible to use inexpensive coloring materials.

Next, we will describe the constitution of the device. With this embodiment, we will describe the constitution of a printer as the device. FIG. 2 is a cross section diagram showing the constitution of the printer. As shown in FIG. 2, the printer 10 of this embodiment performs printing by giving an impact using a printing wire (not illustrated) provided inside the printing head 3 via an ink ribbon 13 on printing paper 6 as a printing medium arranged between a platen 2 and the printing head 3.

The printing paper 6 is fed from the paper feeding port 7 provided in the case 1 of the printer 10 and wound on the platen 2, printing is performed by the printing head 3 (in addition to numbers, letters and the like, this is a broad concept also including printing graphs using dots or the like), and the paper is ejected from a paper ejection port 9. A carriage 4 can be guided by a guide shaft 5 and moved in the axial direction. The ink ribbon 13 is interposed between the printing head 3 and the printing paper 6, and the printing head 3 fixed to the carriage 4 performs printing by driving a plurality of printing wires provided inside the printing head 3 at a desired timing while moving in the axial direction.

A freely openable/closable cover 11 and a paper ejection port cover 12 are attached to a case member 1, and the paper ejection port cover 12 is rotatably connected to the cover 11. Also, the paper ejection port cover 12 is constituted with a transparent, light member, so the printing paper 6 is easy to see, and it is easy to take it out. Then, the printed printing paper 6 is ejected from the paper ejection port 9 along a paper guide 8.

Also, the printer 10 is equipped with the sound absorbing body 200 that absorbs noise (does sound absorption). The constitution of the sound absorbing body 200 is the same as the constitution in FIG. 1, so we will omit a description. With this embodiment, the sound absorbing body 200 is arranged at the part corresponding to the periphery of the printing head 3 of the case member 1. In specific terms, it is arranged at the case surface 1a of the part corresponding to the side opposite to the drive part of the printing head 3 of the case member 1. Furthermore, the sound absorbing body 200 is also arranged on the cover 11 corresponding to above the printing head 3. The specific arrangement method is to attach such that the surface corresponding to the dense part 210 of the sound absorbing body 200, specifically, the one surface 200a, contacts the case surface 1a. By doing this, when noise occurs with driving of the printing head 3, the generated noise enters the sound absorbing body 200, and while the sound is being reflected by the dense part 210, the reflected sound is propagated by the non-dense part 220, so in that process, the sound is effectively absorbed, and it is possible to prevent the diffusion of noise inside the case member 1.

With this embodiment, we described an example of a printer as the device, but the invention is not limited to this, and it is also possible to apply this to various types of devices that require sound absorption.

As described above, with the first embodiment, the following effects can be obtained.

(1) The sound absorbing body 200 has a dense part 210 and a non-dense part 220, and when sound enters the sound absorbing body 200, sound is reflected by the dense part 210, and sound is propagated by the non-dense part 220. By doing this, it is possible to attenuate the sound. Then, it is possible to increase the sound absorption effect without making the thickness of the sound absorbing body 200 thicker. Also, the sound absorbing body 200 is constituted as one unit. Specifically, it is formed as an integrated unit. Because of that, for example compared to an item for which the dense parts 210 and the non-dense parts 220 are formed separately and alternately laminated, management of the adhesion of the lamination boundaries and the like is unnecessary, and it is possible to perform handling easily.

(2) Coloring is implemented on the one surface 200a corresponding to the dense part 210 of the sound absorbing body 200, so it is easy to distinguish between the one surface 200a and the other surface 200b. By doing this, when attaching to some type of apparatus or device, it is possible to prevent making an error in the attachment direction of the sound absorbing body 200.

(3) With the printer 10 equipped with the sound absorbing body 200 noted above, it is possible to efficiently reduce noise during driving of the printing head 3. Furthermore, the colored one surface 200a side corresponding to the dense part 210 of the sound absorbing body 200 is adhered to the case surface 1a of the case member 1 of the printer 10, so the colored surface is hidden with the external view. Because of this, it is no longer necessary to particularly restrict the color for coloring, and it is possible to use an inexpensive coloring material By doing this, it is also possible to suppress the costs for the printer overall.

### Second Embodiment

Next, we will describe the second embodiment of the present invention.

First, we will describe the constitution of the sound absorbing body. FIGS. 3A to 3D are pattern diagrams showing the constitution of the sound absorbing body of this embodiment. The sound absorbing body 201 is an item for which fibers are the main constituent, and for example, is an item attached to the surface of a case member of an apparatus, for absorbing noise generated from the apparatus (doing sound absorption). FIG. 3A is a lateral cross section view. As shown in FIG. 3A, the density differs between one surface side and the other surface side in the thickness direction T of the rectangular solid form sound absorbing body 201, and the color also differs between one surface and the other surface.

With the sound absorbing body 201 of this embodiment, the constitution is such that the one surface 201a side in the thickness T direction of the sound absorbing body 201 formed as one unit (one item) is the dense density part 210, and the other surface 201b side is the non-dense part 220. Then, the dense part 210 includes many of the fibers for which the fiber length is shorter than that of the non-dense part 220. With the sound absorbing body 201 constituted in this way, for example when sound enters from the non-dense part 220, the entered sound passes through the non-dense part 220 and is reflected by the dense part 210. Then, the reflected sound is again propagated in the non-dense part 220. Then, the sound is attenuated with this process. By doing this, it is possible to obtain a sound absorbing effect.

It is also possible to laminate a plurality of sound absorbing bodies 201. By doing this, it is possible to further increase the sound absorbing effect.

The sound absorbing body 201 is an item formed from a mixture including cellulose fiber, molten resin, and flame retardant, and the density of the non-dense part 220 and the dense part 210 is the density of the cellulose fiber, the molten resin, or the flame retardant. The cellulose fibers, molten resin, and flame retardant are the same as for the first embodiment, so a description will be omitted. Also, the method for forming the sound absorbing body 201 is also the same as with the first embodiment, so a description will be omitted.

FIG. 3B is a plan view of the sound absorbing body 201 seen from one surface 201a side, and FIG. 3C is a plan view of the sound absorbing body 201 seen from the other surface 201b side. As shown in FIGS. 3B and 3C, the color is different with the one surface 201a and the other surface 201b. With this embodiment, coloring is implemented on the other surface 201b. Specifically, coloring is implemented on the surface corresponding to the non-dense part 220. In specific terms, the cellulose fiber, molten resin, or flame retardant is colored. As a coloring agent, for example, it is possible to suitably use carbon black, a pigment power or the like.

The coloring method is not particularly restricted. For example, after the sound absorbing body 201 is formed, it is possible to color the other surface 201b using a printing device, or to write using spraying or various writing instruments or the like. Also, as the coloring method, it is possible to color the other surface 201b in its entirety, or to implement coloring on only a portion of the other surface 201b. Also, coloring can be constituted using only one color, or with a plurality of colors. Furthermore, it is also possible to express the color as a symbol. Here, a symbol is not particularly restricted as long as it is colored, including letters, numbers, marks or the like. It is also possible to note as a symbol the specified position and sequence for attaching to the apparatus. With this embodiment, coloring was done using a color similar to the color of the apparatus attachment surface.

FIG. 3D is a pattern diagram showing the method of attaching the sound absorbing body 201 to an apparatus M. As shown in FIG. 3D, the surface corresponding to the dense part 210 of the sound absorbing body 201, specifically, the one surface 201a, is attached to the case surface 1a of the case member 1 of the apparatus M. Therefore, the other surface 201b corresponding to the non-dense part 220 is arranged on the front surface side.

The one surface 201a in relation to the dense part 210 is arranged on the apparatus M side, so sound easily passes through from the non-dense part 220 which is the front surface side, and it is possible to do sound absorption. Also, because coloring is implemented on the other surface 201b side which is the front surface side of the sound absorbing body 201 in relation to the apparatus M, when attaching the sound absorbing body 201 to the apparatus M, it is possible to prevent making errors in the attachment surface of the sound absorbing body 201. Furthermore, by having the color of the other surface 201b of the sound absorbing body 201 be similar to the color of the apparatus M (case surface 1a), it is possible to not have the existence of the sound absorbing body 201 stand out. The constitution of the device in which the apparatus is placed is the same as that of the first embodiment, so a description will be omitted.

As described above, with the second embodiment, in addition to the effects of the first embodiment, the following effects can also be obtained.

The other surface 201b corresponding to the non-dense part 220 of the sound absorbing body 201 is colored, and the colors of the one surface 201a and the other surface 201b are different. By doing this, it is possible to prevent making errors in the attachment direction of the sound absorbing body 201 to the case surface 1a of the printer 10 as the device. Furthermore, because the color of the other surface 201b is made to be similar to that of the apparatus M (case surface 1a), it is possible to make the existence of the sound absorbing body 201 not stand out.

### Third Embodiment

Next, we will describe the third embodiment of the present invention.

First, we will describe the constitution of the sound absorbing body. FIGS. 4A to 4D are pattern diagrams showing the constitution of the sound absorbing body of this embodiment. The sound absorbing body 202 is an item for which fibers are the main constituent, and for example, is an item attached to the surface of a case member of an apparatus, for absorbing noise generated from the apparatus (doing sound absorption). FIG. 4A is a lateral cross section view. As shown in FIG. 4A, the density differs between one surface side and the other surface side in the thickness direction T of the rectangular solid form sound absorbing body 202, and the color also differs between one surface and the other surface.

With the sound absorbing body 202 of this embodiment, the constitution is such that the one surface 202a side in the thickness T direction of the sound absorbing body 202 formed as one unit (one item) is the dense density part 210, and the other surface 202b side is the non-dense part 220. Then, the dense part 210 includes many of the fibers for which the fiber length is shorter than that of the non-dense part 220. With the sound absorbing body 202 constituted in this way, for example, when sound enters from the non-dense part 220, the entered sound passes through the non-dense part 220 and is reflected by the dense part 210. Then, the reflected sound is again propagated in the non-dense part 220. Then, the sound is attenuated with this process. By doing this, it is possible to obtain a sound absorbing effect.

It is also possible to have a constitution for which a plurality of sound absorbing bodies 202 are laminated. By doing this, it is possible to further increase the sound absorbing effect.

The sound absorbing body 202 is an item formed from a mixture including cellulose fiber, molten resin, and flame retardant, and the density of the non-dense part 220 and the dense part 210 is the density of the cellulose fiber, the molten resin, or the flame retardant. The cellulose fibers, molten resin, and flame retardant are the same as for the first embodiment, so a description will be omitted.

FIGS. 4B and 4C are plan views of the one surface 202a side and the other surface 202b side. As shown in FIGS. 4B and 4C, the color is different with the one surface 202a and the other surface 202b. With this embodiment, the cellulose fiber is colored when the sound absorbing body 202 is formed, so the dense part of the one surface 202a side is formed to appear darker in color than the non-dense part of the other surface 202b side.

Here, as the sound absorbing body 202 forming method, for example, a mixture for which cellulose fiber, molten resin, flame retardant, and a coloring agent are mixed are placed in a sieve, and this is deposited on a mesh belt arranged beneath the sieve to form a deposit. At this time, for example, depositing is done while suctioning using a suction device. By doing this, it is possible to deposit while biasing the short fibers to one surface side, to form the dense part at one surface side, and to form a darker color part. Then, the deposited deposit substance undergoes pressurization heat treatment. By doing this, the molten resin is melted, and this is formed to a desired thickness. Furthermore, by die cutting to a desired dimension, the sound absorbing body 202 is formed.

FIG. 4D is a pattern diagram showing the method of attaching the sound absorbing body 202 to an apparatus M. With this embodiment, as shown in FIG. 4D, the surface corresponding to the dense part 210 of the sound absorbing body 202, specifically, the one surface 202a, is attached to the case surface 1a of the case member 1 of the apparatus M. Therefore, the other surface 202b corresponding to the non-dense part 220 is arranged on the front surface side.

The one surface 202a in relation to the dense part 210 is arranged at the apparatus M side, so sound easily passes through from the non-dense part 220 which is the front surface side, and it is possible to do sound absorption. Furthermore, the one surface 202a which is the surface of the sound absorbing body 202 attached to the apparatus M has a darker color than the other surface 202b. By doing this, when attaching the sound absorbing body 202 to the apparatus M, it is possible to prevent making errors in the attachment surface of the sound absorbing body 202. The constitution of the device in which the apparatus M is placed is the same as for the first embodiment, so a description will be omitted.

As described above, with the third embodiment, in addition to the effects of the first and second embodiments, the following effects can be obtained.

The one surface 202a corresponding to the dense part 210 is colored with a darker color than the other surface 202b corresponding to the non-dense part 220. By doing this, it is possible to prevent making errors in the attachment direction of the sound absorbing body 202 to the case surface 1a of the printer 10. Also, it is not necessary to do separate coloring after the sound absorbing body 202 is formed, so it is possible to reduce the man hours.

### EXAMPLES

Next, we will describe specific examples of the present invention.

### 1. Mixture

### (1) Cellulose Fiber

A pulp sheet cut into several cm using a cutting machine was fibrillated into floc using a turbo mill (made by Turbo Kogyo Co., Ltd.).

### (2) Molten Resin

This is polyethylene having a core-sheath structure, with the sheath melted at 100° C. or greater, and the core being 1.7 dtex molten fiber consisting of polyester (Tetoron, made by Teijin, Ltd.).

### (3) Flame Retardant

Aluminum hydroxide B53 (made by Nippon Light Metal Co., Ltd.)

### (4) Coloring Agent

Carbon black

### 2. Formation of the Sound Absorbing Body

### Example 1

### Formation of the Sound Absorbing Body A

First, coloring agent was deposited on a mesh belt. Then, 100 weight parts of cellulose fiber, 15 weight parts of molten fiber, and 5 weight parts of flame retardant were air mixed, and the mixed mixture C1 was passed through a sieve and deposited on the coloring agent deposited material. At this time, so that the flame retardant that was smaller than the cellulose fibers and molten resin, as well as cellulose fibers of shorter length among the cellulose fibers, would be gathered at the lower side, depositing on the mesh belt was done while controlling suction using a suction device. Then, the deposited deposit substance underwent pressurization heat treatment at 200° C. After that, this was cut to 29 mm and 10 mm thick to form sound absorbing body A. When the density of that sound absorbing body A was measured, the density of the one surface side and the other surface side in the thickness direction were not uniform, but rather the density of the lower layer side corresponding to the one surface side deposited on the mesh belt side was 0.17 g/cm³, and the density of the upper layer side corresponding to the other surface side was 0.15 g/cm³, and the density of the lower layer side corresponding to the one surface side was higher than the density of the upper layer side corresponding to the other surface side. Also, many shorter length cellulose fibers and shorter length molten resin were distributed on the lower layer side corresponding to the one surface side. Then, coloring was implemented on the high density one surface side.

### Example 2

### Formation of the Sound Absorbing Body B

A mixture C2 for which 100 weight parts of cellulose fiber, 25 weight parts of molten fiber (average fiber length 3 mm), 10 weight parts of flame retardant, and 3 weight parts of coloring agent were air mixed was formed. Also, mixture C3 for which 100 weight parts of cellulose fiber, 15 weight parts of molten fiber (average fiber length 5 mm), and 10 weight parts of flame retardant were air mixed was formed. Then, without using a suction device, these were deposited on the mesh belt. First, the mixture C2 was passed through a sieve and allowed to fall freely, and it was deposited by its own weight on the mesh belt. After that, the mixture C3 was passed through a sieve facing above the deposited mixture C2 and allowed to fall freely, with the mixture C3 deposited by its own weight on the mixture C2. Then, the deposited deposit material underwent pressurization heat treatment at 200° C. After that, this was cut to 29 mm and 10 mm thick to form sound absorbing body B. When the density of that sound absorbing body B was measured, the density of the one surface side and the other surface side in the thickness direction were not uniform, but rather the density of the lower layer side corresponding to the one surface side deposited on the mesh belt side (0.17 g/cm³) was higher than the density of the upper layer side corresponding to the other surface side (0.15 g/cm³). Also, many shorter length cellulose fibers and shorter length molten resin were distributed on the lower layer side corresponding to the one surface side. Furthermore, coloring was implemented on the lower layer side.

### Comparison Example 1

### Formation of the Sound Absorbing Body R

100 weight parts of cellulose fiber, 15 weight parts of molten fiber, and 5 weight parts of flame retardant were air mixed, and the mixed mixture C1 was passed through a sieve and deposited. At this time, depositing was done on a mesh belt while controlling suction using a suction device. Then, the deposited deposit material underwent pressurization heat treatment at 200° C. After that, this was cut to 29 mm and 10 mm thick to form sound absorbing body R. When the density of that sound absorbing body R was measured, the density of the one surface side and the other surface side in the thickness direction were not uniform, but rather the density of the lower layer side corresponding to the one surface side deposited on the mesh belt side was 0.17 g/cm³, and the density of the upper layer side corresponding to the other surface side was 0.15 g/cm³, and the density of the lower layer side corresponding to the one surface side was higher than the density of the upper layer side corresponding to the other surface side.

### 3. Evaluation and Results

Next, for the example 1, the example 2, and the comparison example 1 noted above, for the one surface corresponding to the dense part with high density and the other surface corresponding to the low density part, using a visual inspection of the external appearance, an evaluation was done of whether or not it was possible to distinguish between the one surface and the other surface. As a result, with example 1 and example 2, coloring was implemented on the one surface, so it was possible to easily distinguish between the one surface and the other surface. Meanwhile, with the comparison example 1, coloring is not done on either the one surface or the other surface, so it was not possible to distinguish between the one surface and the other surface.

As the verification method for the dense part and the non-dense part which are feature points of this application, ink or the like was dripped on the front surface and the back surface, and it can be said that the non-density/density is different if there is a difference in the ease of infiltration. When the entire sound absorbing body has uniform density, when ink is dripped, infiltration occurs almost uniformly on both the front surface and the back surface.

Following, we will describe modification examples.

With the embodiments noted above, to prevent fuzz on the surface of the sound absorbing body 200, 201, and 202 and the like, it is possible to adhere a thin non-woven cloth to the surface. Since adhered non-woven cloth is thinner than the sound absorbing body 200, 201, and 202, there is little effect on the sound absorbing properties.

With the embodiments noted above, the sound absorbing body 200, 201, and 202 were a rectangular solid, but the invention is not limited to this. It is also possible to have a notch or recess in a portion of the rectangular solid, or to have a circular arc part or a sloped part rather than a rectangular solid.

With the embodiments noted above, lamination was done such that the thickness of the layer corresponding to the non-dense parts 220 was thicker than the thickness of the layer corresponding to the dense parts 210, but the invention is not limited to his constitution. For example, it is also possible to have the thickness of the layer corresponding to the non-dense parts 220 be the same thickness as the thickness of the layer corresponding to the dense parts 210. Even when set in this way, it is possible to increase the sound absorbing effect.

We noted the density for each embodiment and comparison example, but these are merely examples. Also, densities are numbers for the greatest locations and the least locations.

With the embodiments noted above, the pulp sheet includes wood pulp such as of conifer trees, broad leafed trees and the like, non-wood plant fibers such as of hemp, cotton, kenaf and the like, and used paper and the like.

With the embodiments noted above, cellulose fiber was the main constituent, but as long as it is a material that absorbs sound, and can be given density differences, this is not limited to cellulose fiber. It is also possible to use fiber with a raw material of a plastic such as polyurethane or polyethylene terephthalate (PET) or the like, or another fiber such as wool or the like.

The method for forming the sound absorbing body is not limited to the method noted with the embodiments noted above. As long as the features of this application can be presented, another manufacturing method such as a wet method or the like can also be used.

With the embodiments noted above, we described the printer 10 as an example of the device for attaching the sound absorbing body 200, 201, and 202, but the invention is not limited to this, and it is possible to use this on other various devices. Also, in addition, as the type of apparatus for attaching the sound absorbing body 200, 201, and 202, for example, it is also possible to attach to the printing head 3 of the printer 10 in FIG. 2. In this case, the sound absorbing body 200, 201, and 202 are attached so as to cover a part or all of the printing head 3. By working in this way, it is possible reduce the noise generated from the printing head 3. Furthermore, in addition to the printing head 3, it is also possible to attach to various types of drive devices such as a motor or the like. Working in this way as well, it is possible to obtain the same effects as noted above.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A sound absorbing body comprising:
fibers as a main constituent, wherein
a density of the sound absorbing body differs for one surface side and the other surface side in a thickness direction, and
a color of the sound absorbing body differs for the one surface side and the other surface side.

2. The sound absorbing body according to claim 1, wherein
the sound absorbing body is attached to an apparatus, and
one of the one surface and the other surface of the sound absorbing body attached to the apparatus corresponds to a dense part for which the density is high, and
coloring is implemented on the one of the one surface and the other surface of the sound absorbing body corresponding to the dense part.

3. The sound absorbing body according to claim 2, wherein
the density of the sound absorbing body is the density of the fibers, and
the fibers are colored.

4. The sound absorbing body according to claim 3, wherein
the sound absorbing body includes the dense part and a non-dense part with a lower density than the dense part,
the dense part includes more fibers for which a fiber length is shorter than that of the non-dense part.

5. The sound absorbing body according to claim 2, wherein
the sound absorbing body includes flame retardant,
the density of the sound absorbing body is the density of the flame retardant, and
the flame retardant is colored.

6. The sound absorbing body according to claim 2, wherein
the sound absorbing body includes molten resin,
the density of the sound absorbing body is the density of the molten resin, and
the molten resin is colored.

7. The sound absorbing body according to claim 2, wherein
coloring is done by writing a symbol on the one of the one surface and the other surface of the sound absorbing body attached to the apparatus.

8. The sound absorbing body according to claim 1, wherein
the sound absorbing body is attached to an apparatus, and
one of the one surface and the other surface of the sound absorbing body attached to the apparatus corresponds to a dense part with high density, and
coloring is implemented on the other of the one surface and the other surface of the sound absorbing body corresponding to a non-dense part which has a lower density than the dense part.

9. The sound absorbing body according to claim 8, wherein
the color used for coloring is similar to a color of the apparatus attachment surface.

10. A device comprising:
the sound absorbing body according to claim 1, and
an apparatus.
